(19) United States
(12) Patent Application Publication
(10) Pub. No.: US 2010/0250986 A1
(43) Pub. Date: Sep. 30, 2010

(54) Method and Device for Improving Battery Life of a Mobile Computing Device

(75) Inventors: Gregory R. Black, Vernon Hills, IL (US); John P. Boos, Grayslake, IL (US); Richard G. Hartwig, Menlo Park, CA (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/630,036

(22) Filed: Dec. 3, 2009

Related U.S. Application Data
(60) Provisional application No. 61/163,981, filed on Mar. 27, 2009.

(51) Int. Cl. G06F 1/32; G06F 17/30

(52) U.S. Cl. 713/323; 707/618; 713/320; 707/E17.005

(57) ABSTRACT

A method (150) and device (200) adapted to run an application in synchronous communication with an application server is described. The method (150) can include the steps of: detecting (155) motion in proximity to the mobile computing device; and adjusting (160) a synchronization interval between the mobile computing device and a server in response to the detected motion. The method and device can provide substantial energy savings in an energy storage device for a mobile computing device and provides a useful compromise for energy conservation on one hand, while also accommodating a user's demand for a short synchronization interval when desired, on the other.

### FIELD OF THE INVENTION

The field of the invention relates to mobile computing devices and the energy storage device for mobile computing devices.

### BACKGROUND OF THE INVENTION

Mobile computing devices, such as mobile or wireless stations, cellphones, radios, laptops, wireless communication devices and the like, operate with a power storage device with a limited energy supply, such as a battery, fuel cell or the like. A mobile computing device needs a power source and, in many cases, this power source is a battery. For instance, cellular phones use various types of batteries to operate. The amount of time a mobile station can typically operate before the energy of the battery is consumed (which is often referred to as “battery life”), is often an important criteria that consumers use in choosing one brand or type of mobile computing device over another brand. The terms battery, energy storage device and power storage device are used interchangeably herein.

While the power storage device is generally rechargeable, it may not be convenient or even possible for a user to recharge. Accordingly, there is a need to maximize the useful operational time of a wireless computing device.

Additionally, different operating environments can cause the user to be surprised and/or frustrated when the battery runs out much more quickly than would typically be expected by the user. Thus, a variation or unexpected short battery life is very undesirable from a user perspective.

This is a particularly relevant problem for mobile computing devices running applications supported by an applications server because of the power drain due to the wireless data exchange between the mobile device and the server, since each download causes the consumption of energy in the mobile device and server. The problem is especially acute in the mobile device, which is typically battery powered and has finite energy available. For example, a mobile device may employ an email server for uploading and downloading email in support of an email application, a contact server for uploading and downloading contact status in support of a social networking application, an information server for downloading movies, news, music, etc. in support of a media playing application, and a back-up/storage server for uploading mobile device data in support of a data back-up application. Typically, the mobile device and application server synchronize on a regular or periodic basis, i.e. they upload, download or exchange information at essentially regular or fixed time intervals, and in this document, the amount of time between data exchanges is referred to as the “synchronization interval”, for a given application and application server. Thus, there is a need for increasing a length of a synchronization interval, in order to conserve energy in a power storage device of a wireless computing device, such as a mobile station, in order to prolong useful power storage device or battery life.

Generally, there is a tradeoff between good application performance which requires more frequent data exchanges, i.e. a short synchronization interval, and good battery life which requires less frequent data exchanges, i.e. a long synchronization interval. For example, performance of an email application may be determined by the amount of time it takes to receive an email, and performance of a social networking application may be determined by the delay in receiving a change in a contact's status.

It is known to vary the synchronization interval according to a schedule, such that the period between downloading increases when certain applications are less likely to require frequent downloads. However, since application usage is a human behavior, the optimum download period cannot always be predicted and scheduled.

Thus, there is a need to provide a longer downloading synchronization interval or period for drawing less energy consumption at certain “dormant times”, while also providing shorter downloading synchronization interval at “active times”, when an application requires timely information.

### BRIEF DESCRIPTION OF THE DRAWINGS

FIG. 1 is a block diagram of a system for improving the battery life of a mobile computing device according to the present invention;

FIG. 2 is a flowchart of one example of an approach for improving the battery life of a mobile computing device according to the present invention;

FIG. 3 is a block diagram of a mobile computing device that provides for an improved battery life according to the present invention;

FIG. 4 is state diagram of a mobile computing device running an application in synchronous communication with an application server according to the present invention;

FIG. 5 is a first flow diagram of a power saving module according to the present invention; and

FIG. 6 is a second flow diagram of a power saving module according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to \help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method is described that adjusts the length of the synchronization interval associated with a mobile computing device (or mobile station, wireless communication device, wireless computing device, mobile or wireless station, cellphone, radio, laptop and the like, such terms used interchangeably herein) in order to conserve and improve the life of an energy storage device in connection with a mobile computing device. The approaches described herein allow a mobile computing device to operate in a variety of conditions and provide a variety of bandwidth intensive services without substantially compromising the energy storage device in association with the mobile station.

Adjustments to the synchronization interval may be made in a variety of different ways. In one example, the length of the synchronization interval may be dynamically increased, and in another example, the length may be dynamically decreased, as detailed below.

Further adjustments may also be made. For instance, if the synchronization interval has been lengthened, the length may be returned to its original length, after the expiration of a period of time or by an over ride, again as detailed below.

Thus, approaches are described whereby the power storage device of the mobile computing device is improved even under less than ideal operating conditions and different modes of operation. Consequently, the mobile computing device can operate under a variety of operating conditions.

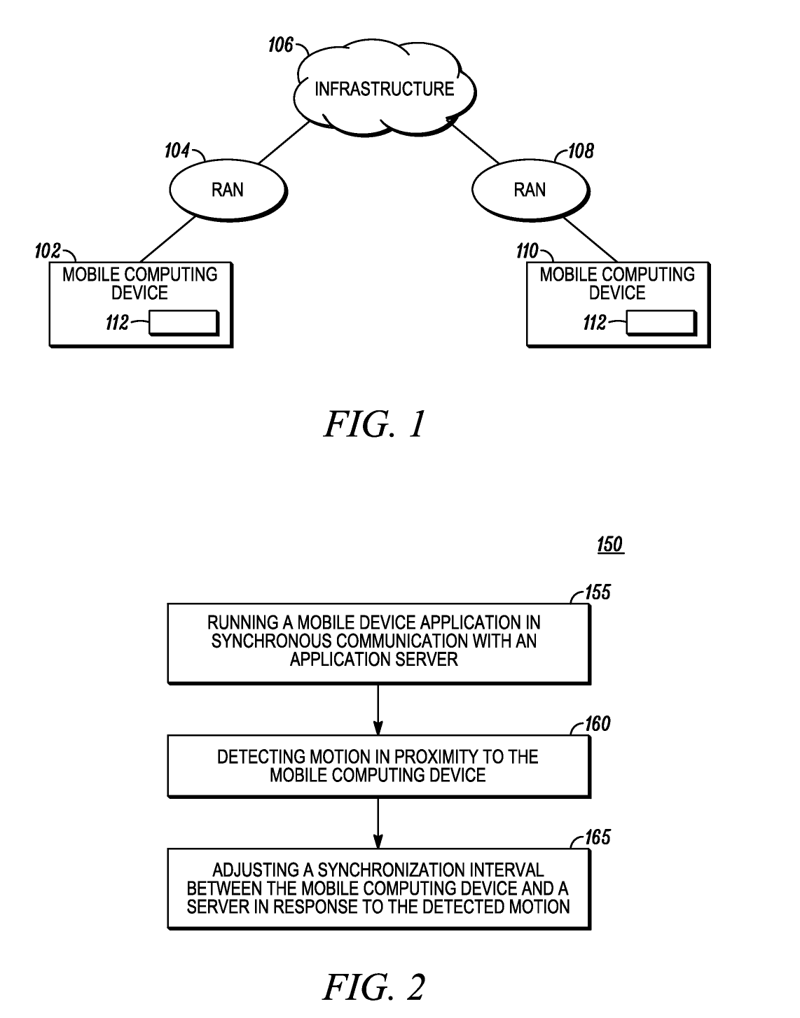

Referring now to FIG. 1, one example of a system for increasing the battery life of a mobile computing device is described. The system includes a first mobile computing device 102 that is coupled to a first Radio Access Network (RAN) 104. The first RAN 104 is coupled to a communication infrastructure 106. A second mobile computing device 110 is coupled to a second RAN 108. The second RAN 108 is also coupled to the infrastructure 106. The principles described herein may be applied to a variety of systems, such as long-term evolution (LTE), ultra mobile wideband (UMB), 802.16e & m, High Rate Packet Data (HRPD) systems, or systems such as the Universal Mobile Telecommunication System (UMTS).

The mobile computing devices 102 and 110 may be any type of mobile wireless device. The mobile computing devices 102 and 110 each include a motion detector 112 for detecting movement or motion in proximity to mobile computing devices 102 and 110, as detailed below. For example, the mobile computing devices 102 and 110 may be cellular telephones, pagers, radios, mobile stations, personal computers, or personal digital assistants. As should be understood by those skilled in the art, other examples of mobile computing devices are possible.

The RANs 104 and 108 may be any device or combination of devices that allow the mobile computing devices 102 and 110 to have access to the communication infrastructure 106. For example, the RANs 104 and 108 may include base stations, base station controllers, antennas, and other types of devices that facilitate these communications.

The communication infrastructure 106 preferably includes devices and/or networks that allow communications to be made between mobile stations. For example, the infrastructure 106 may include switches, servers, storage devices, and networks (e.g., wireless networks, the Internet, landline telephone networks) that facilitate communications between the mobile computing devices 102 and 110.

Referring now to FIG. 2, one example of an approach for extending the useful life of an energy storage device of a mobile computing device is described. In one embodiment, a method 150 for extending the battery life of a mobile computing device running an application in synchronous communication with an application server, can include the steps of: running 155 an application in synchronous communication with an application server, detecting 160 motion in proximity to the mobile computing device; and adjusting 165 a synchronization interval between the mobile computing device and a server in response to the detected motion. This method can provide substantial energy savings in an energy storage device for a mobile computing device.

In a preferred embodiment, the adjusting step 165 can include substantially instant triggering of synchronization signaling between the mobile computing device and the application server, when motion is detected. In one embodiment and in more detail, the triggering step 165 can be configured to substantially immediately begin communication between an application running on the mobile computing device in synchronous communication with the application server, when motion is detected.

Similarly, the adjusting step 165 can include reducing the synchronization interval when motion is detected. In one embodiment and in more detail, the reducing step can be configured to substantially immediately begin communication between an application running on the mobile computing device in synchronous communication with the application server, when motion is detected.

Similarly, the adjusting step 165 can include increasing the synchronization interval when a lack motion is detected for a period of time. The triggering, reducing or increasing, of the synchronization interval, improves application performance by providing more timely data synchronization when it is more likely to be needed, when motion is detected (in an active mode), and conversely, allows a larger or increased synchronization interval to be employed then in a previously step, such as a running step 155, which can provide a lower energy drain (a dormant mode).

These features or steps can improve performance and a user's experience, by providing immediate communication between a mobile computing device and application server. Advantageously, these features allow the mobile computing device to move to an active mode and begin a down load from a server, when motion is detected, by a user moving or passing his or her hand near the mobile computing device.

Alternatively, the adjusting step 165 can include increasing the synchronization interval when lack of motion is detected after a predetermined period of time, thus going into a dormant mode, which could provide substantial energy savings. In more detail, the step of increasing the synchronization interval is configured to reduce the power drain of the mobile computing device, in order to conserve energy of an energy storage device associated with the mobile computing device, when the mobile computing device is not in active use by a user, for example.

Synchronization interval settings vary by application and user preferences. Typically, for an email or social networking application, a daytime or “active” mode interval setting can be 2 to 20 minutes, and a nighttime or “dormant” mode interval setting can be 30 to 120 minutes. For example, an email application may automatically employ a synchronization interval of 10 minutes to achieve acceptable application performance during normal daytime or “active” operation, and employ a synchronization interval of 90 minutes for nighttime or “dormant” operation.

In one embodiment, the method 150 can include a reducing step which includes over-riding a previous synchronization interval setting based on at least one of: a default setting, a user controlled setting, an application server controlled setting, an application state, a present time, a present day, a present date, a state of a clock, and a state of a calendar. Likewise, the adjusting step 165 can include returning to a previous synchronization interval setting based on at least one of: a default setting, a user controlled setting, an application server controlled setting, an application state, a present time, a present day, a present date, a state of a clock, and a state of a calendar.

In a first example, in the previous email application, a mobile computing device is running 155 at a dormant mode interval of 90 minutes. Once a motion is detected, as detailed in step 160, the synchronization interval can be reduced, as in step 165 to 5 minutes. In a second email application example, the mobile computing device is running 155 in an active mode interval of 5 minutes. Since there is a lack of detected motion 160, in proximity to the device for a period of time, and the synchronization interval can be increased, relative to step 165, to 90 minutes, in response to the detected lack of motion.

In one arrangement, the method 150 can include providing a programmable synchronization mode having a dormant mode including a longer synchronization interval when the motion detection indicates that it is unlikely that a higher application performance is needed by a user, and having an active mode including a shorter synchronization interval when the motion detection indicates that it is likely that higher application performance is needed by a user, as indicated by the lack of detection of motion or motion detection, respectively.

Advantageously, this feature can provide a useful compromise for energy conservation of the power storage device on one hand, while also accommodating a user's demand for a short synchronization interval on the other. For example, mobile device users may carry their device during waking hours, and stow their device on a nightstand, in a drawer, or charger during resting or sleeping hours, or when the device is otherwise not being used. Thus, since a user is likely to only need higher application performance while awake, and not need higher application performance while sleeping or resting, motion detection is a good indicator of the need for higher application performance.

In more detail, synchronizing, as used in method 150, can include at least one of uploading application data from the mobile computing device to the application server and downloading application data to the mobile computing device from the application server. The term application, as used herein, can include at least one of email, social networking, and news feeding. In an email or social networking applications, for example, an active user wants to receive new messages, contact status updates, or news stories in a timely manner, e.g. within 5 minutes, but may not care about late delivery, such as over 30 minutes, in a dormant mode.

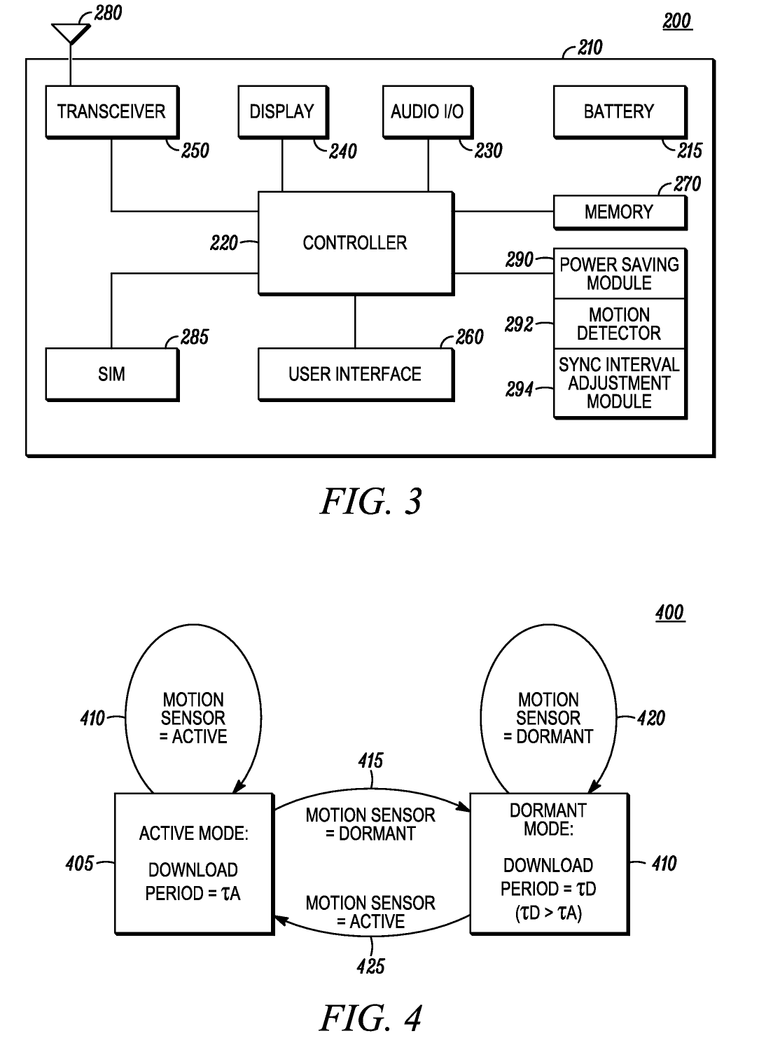

Referring now to FIG. 3, is an exemplary block diagram of a mobile computing device 200, such as the mobile computing devices 102 or 110, according to one embodiment. The mobile computing device 200 can include a housing 210, an energy storage device 215, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210, a transceiver 250, and a removable subscriber identity module (SIM) 285 coupled to the controller 220. The mobile computing device 200 further includes a power saving module 290, a motion detector 292, and a synchronization interval adjustment module 294, which are coupled to the controller 220. In more detail, they can reside within the controller 220, can reside within the memory 270, can be autonomous modules, can be software, can be hardware, or can be in any other format useful for a module on a wireless communication device 200.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory or any other memory that can be coupled to a wireless communication device.

In more detail, the mobile computing device 200 configured with an energy storage device in FIG. 3, includes: a housing 210; a controller 220 coupled to the housing 210, the controller 220 configured to run an application in synchronous communication with an application server; memory 270 coupled to the controller 220; a wireless transceiver 250 coupled to the controller 220 for synchronizing application data between the mobile computing device 200 and the application server (which could reside in infrastructure 106 in FIG. 1); a motion detector 292 configured to detect motion in proximity to the mobile computing device 200; and a power saving module 290 configured to adjust a length of a synchronization interval between the mobile computing device 200 and the application server, in order to conserve energy of the energy storage device 215, in response to the motion detector.

Advantageously, the power saving module 290 and synchronization interval adjustment module 294 can allow the mobile computing device 200 to dynamically manage current drain of a power storage device 215, such as a battery, a fuel cell or electrochemical capacitor. This arrangement can provide a longer useful life for mobile computing device before having to recharge one's power storage device 215.

In one arrangement, the motion detector 112 shown in FIGS. 1 and 292 in FIG. 2, can comprise at least one of an accelerometer, a magnetic field sensor, a compass, an acoustic sensor, a light sensor, a proximity sensor which may comprise a light source and sensor, and the like. The motion detector 292 may include an output signal processor for processing functions such as integrating and filtering, and a threshold detection circuit.

For example, when an accelerometer is utilized, an active mode can be triggered by movement of the mobile computing device 102 or 110. In the case that a magnetic field sensor is utilized, a user could change the device orientation with respect to the earth's magnetic field, or in the case of a proximity sensor, a user could wave a hand or provide a hand gesture in proximity to the mobile computing device 102 or 110, to trigger an active mode.

In one arrangement, the synchronization interval adjustment module 294 is configured to trigger synchronization between the mobile computing device and the application server when motion is detected. Likewise, the synchronization interval adjustment module 294 can be configured to reduce the synchronization interval when motion is detected, defining an active mode. Advantageously, this structure places the mobile computing device in an active mode instantly.

Alternatively, the synchronization interval adjustment module 294 is also configured to increase the synchronization interval when lack of motion is detected for a predetermined period of time, defining a dormant mode for improved longevity of the power storage device 215 and improved performance.

In more detail, in one embodiment, the power savings module 290 is configured to increase the synchronization interval, defining a dormant mode, thereby reducing the power drain of the mobile computing device in order to conserve energy of an energy storage device in the mobile computing device.

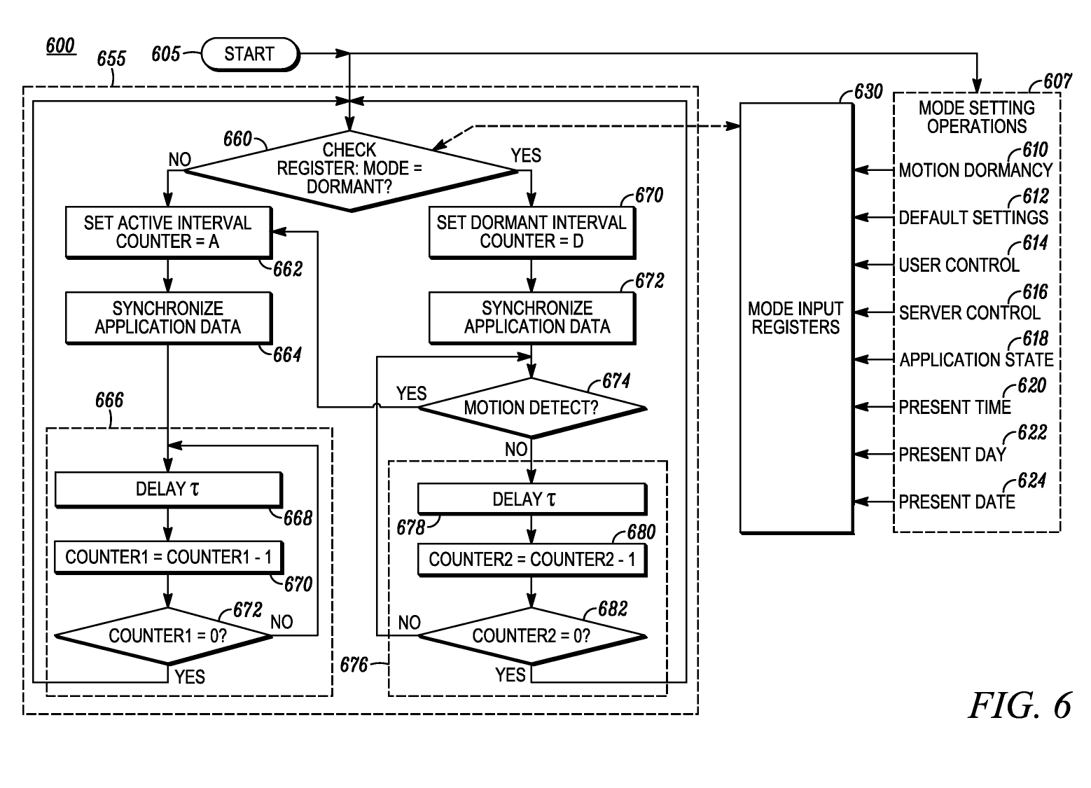

In one arrangement, the dormant mode includes an over-ride of a previous synchronization interval setting, based on at least one of: a default setting, a user controlled setting, an application server controlled setting, an application state, a present time, a present day, a present date, a state of a clock, and a state of a calendar, such as shown as item 607 in FIG. 6.

In one embodiment, the synchronization interval adjustment module 294 is configured to return to a previous or default synchronization interval setting based on at least one of: a default setting, a user controlled setting, an application server controlled setting, an application state, a present time, a present day, a present date, a state of a clock, and a state of a calendar, such as shown as item 607 in FIG. 6.

In more detail, the synchronization interval adjustment module 294 is configured to provide a synchronization mode having: a dormant mode including a longer synchronization interval when the motion detector 292 indicates that it is unlikely that a higher application performance is needed by a user; and an active mode including a shorter synchronization interval when the motion detector 292 indicates that it is likely that higher application performance is needed by a user.

Advantageously, this feature provides a useful compromise for energy conservation of the power storage device on one hand, while also accommodating a user's demand for a short synchronization interval when desired, on the other.

In one embodiment, the instant invention is incorporated into the communication infrastructure and in another it can be incorporated into a wireless communication device. Other placements are possible, such as including being in both.

Thus, approaches are described whereby the energy storage device of a mobile station is improved regardless of the operating environment or mode of the mobile station. Consequently, the mobile computing device can operate in a variety of operating conditions and utilize power-consuming services, while maintaining and improving the lifetime of an energy storage device of the mobile computing device. Because of the method, structure and disclosed approaches detailed herein, the user experience can be significantly enhanced.

Turning to FIG. 4, there is shown a state diagram 400, according to one embodiment. The state diagram 400 is a simplified illustration of the operation of the power saving module 290 configured to control the synchronization interval between the mobile computing device and an application server. In more detail, a first state is the active mode 405 in which the synchronization period is T_{A}. A second state is the dormant mode 410 in which the synchronization period is T_{D}. The mobile computing device uses motion detection, to determine the frequency of data downloading from an application server or uploading to an application server.

While in the active mode 405, if the motion sensor detects motion 410, then the state remains unchanged, and if the motion sensor detects a lack of motion, as shown at line 415, then there is a transition from the active state 405 to the dormant state 410, and the download period changes to T_{D}. Similarly, while in the dormant mode 410, if the motion sensor detects lack of motion, as shown in line 420, then the state remains unchanged, and if the motion sensor detects motion, as shown in line 425, then there is a transition from the dormant mode state 410 to the active mode state 405, and the download period changes to T_{A}. As should be understood by those skilled in the art, while FIG. 4 illustrates two states for controlling the synchronization interval, with two interval settings, additional states featuring different synchronization interval settings, for example, corresponding to different durations, degrees or methods of motion detection, are possible within the scope of this invention.

The state diagram in FIG. 4 provides three related ideas and advantages:
1) Downloading data immediately 425 when the device starts moving or detects motion.
2) Reducing the downloading interval 425 when the device starts moving or detects motion.
3) Increasing the downloading interval 415 when there is a lack of motion for a predetermined period.

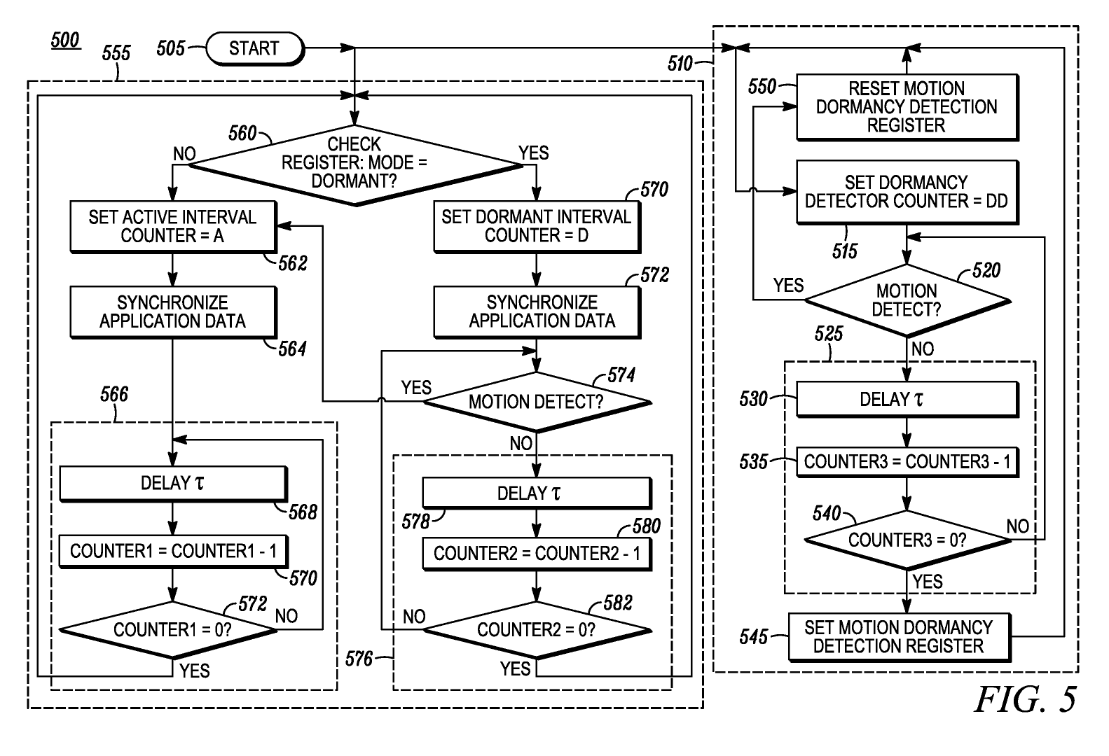

Referring to FIG. 5, there is shown a flow diagram 500, according to one embodiment, for operation of the power saving module 290 for controlling the synchronization interval between the mobile computing device and an application server. Starting from 505, there are two concurrent operations. A dormancy detection operation 510 begins at setting an initial dormancy detection counter 515 to a value, and checking for motion detection 520. If at motion detection diamond 520, there is no motion detected, then the process continues to the running of a motion detection counter 525. The motion detection counter 525 includes the steps of delay T 530, decrementing the counter value 535, and checking if the counter value is zero 540. If at 540 the counter value is not zero, “No”, then the process returns to motion detection diamond 520. If at 540 the counter value is zero, or “Yes”, a dormancy detection register is set at 545, which indicates the dormant state.

If at motion detection diamond 520, motion is detected, or “Yes”, then the dormancy detection register is reset 550, which indicates a non-dormant state, such as the active state. After setting 545 or resetting 550 the dormancy detection register the process returns to dormancy detection counter 515. Thus for the dormancy state to be asserted a lack of motion detection must persist by an amount of time equal to the counter value setting at dormancy detection counter 515, DD, times the delay T at 525.

Concurrent to the dormancy detection process 510, is a synchronization interval control process 555, which begins by checking a mode register 560. The mode register may be the dormancy register which is programmed at 545 and 550. If at 560, the mode register indicates a non-dormant or active mode then an initial active interval counter value is set 562, and the mobile device and application server synchronize 564. The process continues to the running of the active interval counter 566 comprising the steps of a delay 568, decrementing the counter value 570, and checking if the counter value is zero, 572. If at 572 the counter value is not zero, or “No”, then the process returns to 568. If at 572 the counter value is zero, or “Yes”, the process returns to 560. Thus the synchronization interval in the active mode is equal to the counter value setting at 562, A, times the delay T at 568.

If at decision diamond 560, the mode register indicates a dormant mode, as “Yes”, then an initial dormant interval counter value is set at box 570, the mobile device and application server are synchronized at box 572, and there is a check for motion detection at decision diamond 574. If at decision diamond 574, motion is not detected, or “No”, the process continues to the running of the dormant interval counter 576 comprising the steps of a delay T at box 578, decrementing the counter value at box 580, and checking if the counter value is zero, at decision diamond 582. If at decision diamond 582, the counter value is not zero, or “Yes”, then the process returns to decision diamond 560. If at decision diamond 582, the counter value is not zero, or “No”, then the process returns to decision diamond 574. If at decision diamond 574 motion is detected, as “Yes”, then the process goes to the box 562, which effects a change from a dormant to an active mode. (In an alternative embodiment, if at decision diamond 574 motion is detected, then an activity detection register may be set, or a dormancy detection register may be reset, although this is not shown in FIG. 5.) Thus the synchronization interval in the dormant mode is equal to the counter value setting at box 570, D, times the delay T at 578.

Referring to FIG. 6, there is shown a flow diagram 600 according to another embodiment for operation of the power saving module 290 for controlling the synchronization interval between the mobile computing device and an application server. The flow diagram begins at 605.

Concurrent mode setting operations are provided at box 607. Concurrent operations which can control the state of the synchronization interval operation include detection of motion dormancy 610 a preferred embodiment of which is described in 510. Other concurrent operations are default synchronization interval settings 612, user controls 614, application server or other remote controls 616, an application state dependant control 618, the present time 620, the present day 622, and the present date 624. These operations generate inputs to mode registers 630 concurrently with synchronization interval control process 655 which is the same as 555. The mode registers 630 may include the dormancy register programmed at 545 and 550.

The synchronization interval control process 655 begins by checking mode registers 630 at decision diamond 660. This checking may include logical operation on the register states. For a case of multiple registers which are set for the case of dormancy the logical AND of the mode register states is appropriate for checking at 660. If at decision diamond 660, the checking indicates a non-dormant or active mode, or “No”, then an initial active interval counter value is set at box 662, and the mobile device and application server synchronize at box 664. The process continues to the running of the active interval counter 666 comprising the steps of a delay T at box 668, decrementing the counter value at box 670, and checking if the counter value is zero, at decision diamond 672. If at decision diamond 672, the counter value is not zero or “No”, then the process returns to box 668. If at decision diamond 672, the counter value is zero, indicated as “Yes”, then the process returns to decision diamond 660.

The synchronization occurring at 564, 572, 664 and 672 could be the downloading of data from one or more application servers, the uploading of data to one or more application servers, or both.

Those skilled in the art will recognize that a wide variety of modifications, alterations, and combinations can be made with respect to the above described embodiments without departing from the broad scope of the invention, and that such modifications, alterations, and combinations are to be viewed as being within the scope of the invention.

What is claimed is:

1. A method for lengthening the battery life of a mobile computing device running an application in synchronous communication with an application server, comprising the steps of:
detecting motion in proximity to the mobile computing device, and
adjusting a synchronization interval between the mobile computing device and a server in response to the detected motion.

2. The method of claim 1, wherein the adjusting step includes triggering of synchronization signaling between the mobile computing device and the application server when motion is detected.

3. The method of claim 1, wherein the adjusting step includes reducing the synchronization interval when motion is detected.

4. The method of claim 1, wherein the adjusting step includes increasing the synchronization interval when lack of motion is detected after a predetermined period of time.

5. The method of claim 2, wherein the triggering step of the synchronization signaling is configured to substantially immediately begin communication between an application running on the mobile computing device in synchronous communication with the application server, when motion is detected.

6. The method of claim 3, wherein the reducing step of a synchronization interval is configured to substantially immediately begin communication between an application running on the mobile computing device in synchronous communication with the application server, when motion is detected.

7. The method of claim 4, wherein the step of increasing the synchronization interval is configured to reduce the power drain of the mobile computing device, in order to conserve energy of an energy storage device associated with the mobile computing device.

8. The method of claim 3, wherein the reducing step includes over-riding a previous synchronization interval setting based on at least one of:
a default setting, a user controlled setting, an application server controlled setting, an application state, a present time, a present day, a present date, a state of a clock, and a state of a calendar.

9. The method of claim 4, wherein the adjusting step includes returning to a previous synchronization interval setting based on at least one of:
a default setting, a user controlled setting, an application server controlled setting, an application state, a present time, a present day, a present date, a state of a clock, and a state of a calendar.

10. The method of claim 1, further comprising providing a programmable synchronization mode having a dormant mode including a longer synchronization interval when the motion detection indicates that it is unlikely that a higher application performance is needed by a user, and having an active mode including a shorter synchronization interval when the motion detection indicates that it is likely that higher application performance is needed by a user.

11. The mobile computing device of claim 1 wherein synchronizing includes at least one of uploading application data from the mobile computing device to the application server and downloading application data to the mobile computing device from the application server.

12. The mobile computing device of claim 1 wherein the application includes at least one of email, social networking, location determination, and media streaming.

13. A mobile computing device configured with an energy storage device, comprising:
a housing;
a controller coupled to the housing, the controller configured to run an application in synchronous communication with an application server;
memory coupled to the controller;
a wireless transceiver coupled to the controller for synchronizing application data between the mobile computing device and the application server;
a motion detector configured to detect motion in proximity to the mobile computing device; and
a power saving module configured to adjust a length of a synchronization interval between the mobile computing device and the application server in order to conserve energy of the energy storage device, in response to the motion detector.

14. The mobile computing device of claim 13, wherein the power saving module includes a synchronization interval adjustment module, the synchronization interval adjustment module being configured to trigger synchronization between the mobile computing device and the application server when motion is detected.

15. The mobile computing device of claim 13, wherein the power saving module includes a synchronization interval adjustment module, the synchronization interval adjustment module being configured to reduce the synchronization interval when motion is detected, defining an active mode.

16. The mobile computing device of claim 13, wherein the power saving module includes a synchronization interval adjustment module, the synchronization interval adjustment module being configured to increase the synchronization interval when lack of motion is detected for a predetermined period of time, defining a dormant mode.

17. The mobile computing device of claim 16 wherein the power savings module includes a dormant mode configured to increase the synchronization interval, thereby reducing the power drain of the mobile computing device in order to conserve energy of an energy storage device in the mobile computing device.

18. The mobile computing device of claim 15 wherein the dormant mode includes an over-ride of a previous synchronization interval setting, based on at least one of:
a default setting, a user controlled setting, an application server controlled setting, an application state, a present time, a present day, a present date, a state of a clock, and a state of a calendar.

19. The mobile computing device of claim 16 wherein the synchronization interval adjustment module is configured to return to a previous or default synchronization interval setting based on at least one of:
a default setting, a user controlled setting, an application server controlled setting, an application state, a present time, a present day, a present date, a state of a clock, and a state of a calendar

20. The mobile computing device of claim 13 wherein the synchronous communication includes at least one of uploading application data from the mobile computing device to the application server and downloading application data to the mobile computing device from the application server.

21. The mobile computing device of claim 13 wherein the application includes at least one of email, social networking, location determination and media streaming.

22. The mobile computing device of claim 13, wherein the power saving module includes a synchronization interval adjustment module, the synchronization interval adjustment module being configured to provide a synchronization mode having a dormant mode including a longer synchronization interval when the motion detector indicates that it is unlikely that a higher application performance is needed by a user, and having an active mode including a shorter synchronization interval when the motion detector indicates that it is likely that higher application performance is needed by a user.

23. The mobile computing device of 13, wherein the motion detector comprises at least one of an accelerometer, a magnetic field sensor, a compass, a proximity sensor, and a light sensor.
